(19) United States
(12) Patent Application Publication
(10) Pub. No.: US 2013/0188465 A1
(43) Pub. Date: Jul. 25, 2013

(54) OPTICAL READ/WRITE APPARATUS

(71) Applicant: Panasonic Corporation, Osaka (JP)

(72) Inventor: Akinori YUBA, Osaka (JP)

(73) Assignee: PANASONIC CORPORATION, Osaka (JP)

(21) Appl. No.: 13/716,813

(22) Filed: Dec. 17, 2012

(30) Foreign Application Priority Data
Jan. 23, 2012 (JP) 2012-010656

(51) Int. Cl. G11B 7/1263

(52) U.S. Cl. CPC G11B 7/1263
USPC 369/53.36

(57) ABSTRACT

In an embodiment, an optical read/write apparatus performs both the operation of writing data on an optical disc and the operation of reading data written on the disc. The apparatus includes: a motor which drives the disc; a first optical pickup which irradiates the disc with a first light beam, thereby writing data on the disc; a second optical pickup which irradiates the disc with a second light beam and detects the second light beam reflected from the disc, thereby reading the data written by the first pickup on the disc; an evaluation section which obtains a distortion evaluation value of a signal waveform representing the reflected light detected by the second pickup while the disc is being driven by the motor; and a control section which controls, based on the distortion evaluation value, the power of the first light beam emitted from the first pickup.

### BACKGROUND

1. Technical Field

The present disclosure relates to an optical read/write apparatus.

2. Description of the Related Art

A drive that performs a verify operation while writing data is known in the field of optical discs. The “verify” operation means seeing if the data that has been written on an optical storage medium can be read properly. Such a drive needs to perform a write operation and the verify operation using a single optical head. For that reason, since the optical disc needs to be rotated one more time to perform the verify operation on the recorded track, it takes an extra time to get the write operation done.

Japanese Laid-Open Patent Publication No. 2007-80407 discloses a drive with two optical heads, which performs a verify operation by getting the data that has just been written by one of the two optical heads (which will be referred to herein as a “first optical head” for convenience sake) read immediately by the other optical head (which will be referred to herein as a “second optical head” for convenience sake and) which is arranged close to the first optical head.

By adopting such a technique, there is no need to rotate the optical disc one more time to perform a verify operation because the verify operation is performed by the second optical head right after data has been written by the first optical head.

In such a drive with two optical heads, however, if an error occurs when data is being written by the first optical head, the second optical head retries to write the same data on the very sector where the write error has occurred using a different laser power from the laser power that has been used by the first optical head for writing. But if the retry operation has failed again, then the drive aborts the write processing itself.

According to such a method, sometimes the write operation cannot be performed with good stability.

Thus, an embodiment of the present disclosure provides an optical read/write apparatus that can write data with good stability.

### SUMMARY

An optical read/write apparatus according to the present disclosure performs both the operation of writing data on an optical storage medium and the operation of reading data that has been written on the storage medium. The apparatus includes: a motor which drives the optical storage medium; a first optical pickup which irradiates the optical storage medium with a first light beam, thereby writing data on the optical storage medium; a second optical pickup which irradiates the optical storage medium with a second light beam and detects the second light beam that has been reflected from the optical storage medium, thereby reading the data that has been written by the first optical pickup on the optical storage medium; an evaluation section which obtains a distortion evaluation value of a signal waveform representing the reflected light that has been detected by the second optical pickup while the optical storage medium is being driven by the motor; and a control section which controls, based on the distortion evaluation value, the power of the first light beam emitted from the first optical pickup.

The apparatus of the present disclosure includes a control section that controls, based on the distortion evaluation value, the power of the light beam emitted from the first optical pickup, and therefore, can make feedback on the power control and can a stabilized write quality.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 illustrates a configuration for an optical read/write apparatus as an embodiment of the present disclosure.

FIG. 2A illustrates a relation between the uneven sensitivity of an optical disc and two points 30 and 40 that are located close to each other on the optical disc.

FIG. 2B illustrates an example of a mechanism for controlling the positions of the optical pickups 3 and 4.

FIG. 2C shows the location 4a of the light beam spot left by the optical pickup 4.

FIG. 2D illustrates a positional relation between the location 3a of the light beam spot left by the optical pickup 3 and the location 4a of the light beam spot left by the optical pickup 4.

FIG. 3 illustrates how to perform a write operation and a measuring operation to get waveform distortion information using the two optical pickups 3 and 4.

FIG. 4 shows how power control feedback may be carried out according to an embodiment of the present disclosure.

FIG. 5 shows how power control feedback may also be carried out according to an embodiment of the present disclosure.

FIG. 6 shows how β may be used as a signal waveform's distortion evaluation value.

FIG. 7 shows how the degree of asymmetry may be used as a signal waveform's distortion evaluation value.

FIG. 8 is a flowchart showing an exemplary procedure for determining the initial value of write laser power.

### DETAILED DESCRIPTION

Hereinafter, embodiments will be described in detail with reference to the accompanying drawings as needed. It should be noted that the description thereof will be sometimes omitted unless it is absolutely necessary to go into details. For example, description of a matter that is already well known in the related art will be sometimes omitted, so will be a redundant description of substantially the same configuration. This is done solely for the purpose of avoiding redundancies and making the following description of embodiments as easily understandable for those skilled in the art as possible.

It should be noted that the present inventors provide the accompanying drawings and the following description to help those skilled in the art understand the present disclosure fully. And it is not intended that the subject matter defined by the appended claims is limited by those drawings or the description.

In the related art, the write power is adjusted using only a β value as an index on the supposition that the best power of a light beam for writing is uniform over the entire storage plane of a given optical disc. Actually, however, the sensitivity of the recording film and the shape (specifically, the shapes of lands and grooves) and size of an optical disc may vary from one location to another on the optical disc's storage plane. Even with such a variation, however, the accuracy required for optical disc drives of today can still be satisfied sufficiently.

Nevertheless, to write data on an optical storage medium such as an optical disc with even higher accuracy, the present inventors believe that such a variation in those parameters on the storage plane of the optical storage medium should be taken into account. An optical read/write apparatus according to the present disclosure includes: a motor which drives an optical storage medium; a first optical pickup which irradiates the optical storage medium with a first light beam, thereby writing data on the optical storage medium; a second optical pickup which irradiates the optical storage medium with a second light beam and detects the second light beam that has been reflected from the optical storage medium, thereby reading the data that has been written by the first optical pickup on the optical storage medium; an evaluation section which obtains a distortion evaluation value of a signal waveform representing the reflected light that has been detected by the second optical pickup while the optical storage medium is being driven by the motor; and a control section which controls, based on the distortion evaluation value, the power of the first light beam emitted from the first optical pickup.

According to such a configuration, after data has been written by the first optical pickup, the second optical pickup can obtain a distortion evaluation value of a signal waveform based on the light that has been reflected from an area where the data has been written. By reference to this distortion evaluation value, the apparatus can sense that the power of the first light beam has shifted from the best level. Since the power of the first light beam can be controlled quickly based on the distortion evaluation value that has been obtained by the second optical pickup, it is possible to prevent the power of the first light beam from shifting from the best level or minimize such a shift, if any, to say the least. As a result, a stabilized write quality can be recovered in a short time.

In one embodiment, the distortion evaluation value of the signal waveform includes a first evaluation value that increases as the power of the first light beam rises and a second evaluation value with a local minimum value at which the second evaluation value decreasing starts to increase as the power of the first light beam rises, and the control section controls the power of the first light beam based on both of the first and second evaluation values. The first evaluation value may be at least one of the β value and the degree of asymmetry of the signal waveform representing the reflected light, and the second evaluation value may be at least one of the jitter and iMLSE of the signal waveform representing the reflected light.

With such a configuration adopted, the best level or a quasi-best level of the power of the first light beam can be determined easily based on the distortion evaluation value. That is why when the power of the first light beam is changed, it can be determined, based on the distortion evaluation value, whether the power should be increased or decreased.

In another embodiment, the apparatus performs a verify operation by getting the data that has been written by the first optical pickup read by the second optical pickup. If it has turned out, as a result of the verify operation, that the data cannot be read properly, then the data just needs to be written again. In this manner, data can be written highly accurately.

In still another embodiment, the first and second optical pickups are arranged so that there is an interval of 4 mm (millimeters) or less between two beam spots (corresponding to a location where data is going to be written and a location where the distortion of the waveform is detected, respectively) left by the first and second light beams on the optical storage medium. In a situation where the data writing location and the waveform distortion detecting location are so close to each other, even if the best level of the power of the first light beam varies locally within a narrow range on an optical storage medium, such a variation can also be sensed highly accurately.

In yet another embodiment, the optical storage medium is an optical disc to be rotated by the motor, and the first and second optical pickups are arranged so as to irradiate the optical disc with the first and second light beams at two different radial locations.

According to these embodiments of the present disclosure, the power of the first light beam emitted from the first optical pickup is controlled based on the distortion evaluation value of the signal waveform representing the reflected light that has been detected by the second optical pickup, and therefore, the write operation can be performed with good stability. Particularly if the optical storage medium is a write-once medium, the effect of the present disclosure is significant. The reason is that as for a write-once medium, even if it has turned out that there is a problem with the write quality as a result of a very operation that has been performed after every data has been written, the data cannot be rewritten any longer. According to embodiments the present disclosure, a sign of deterioration in write quality can be detected based on the distortion evaluation value while data is being written on the optical storage medium, and the power of the first light beam can be adjusted so as to minimize such deterioration in write quality.

Hereinafter, embodiments of an optical read/write apparatus according to the present disclosure will be described with reference to the accompanying drawings.

### 1-1. Configuration

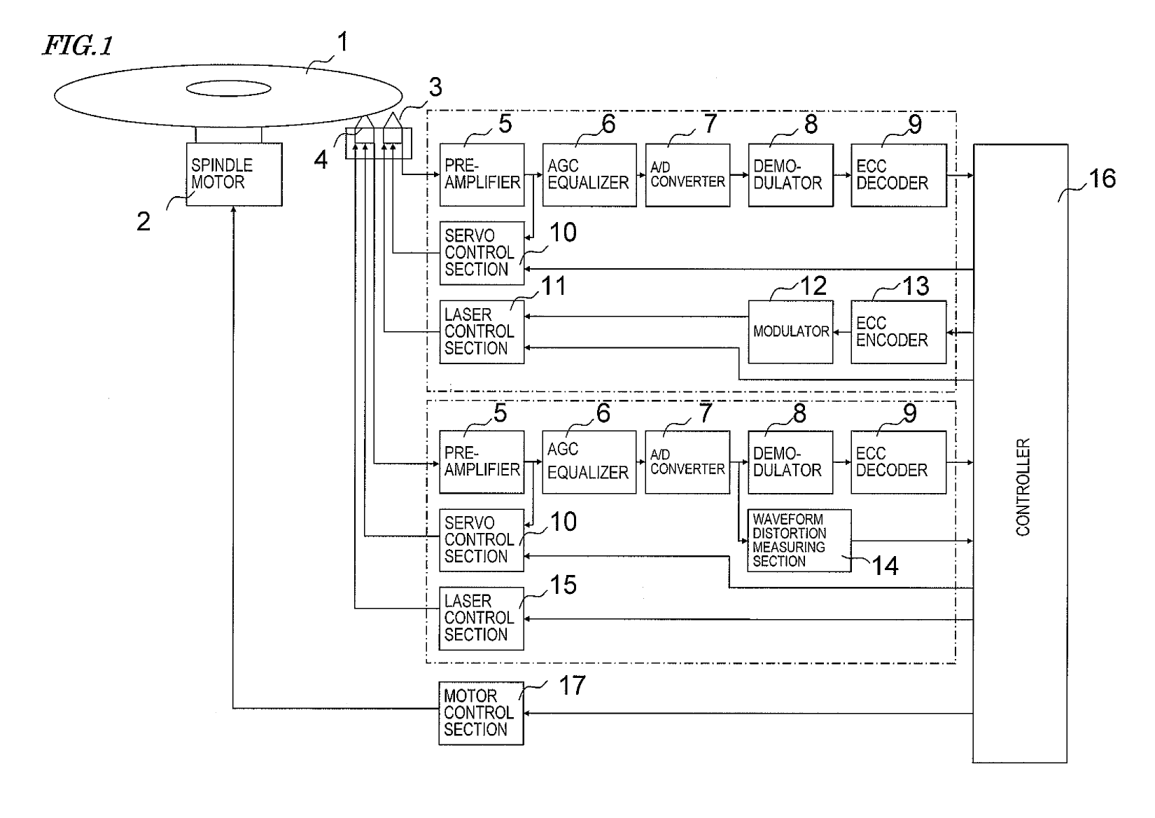

FIG. 1 illustrates a configuration for an optical read/write apparatus according to the present disclosure.

First of all, the configuration of this optical read/write apparatus will be described with reference to FIG. 1. This optical read/write apparatus performs both the operation of writing data on an optical disc and the operation of reading data that has been written on the optical disc. Although an optical disc is used as an example of the optical storage medium in the embodiment to be described below, the optical storage medium according to the present disclosure does not have to be an optical disc but may also be an optical storage medium in the form of a tape (i.e., an optical tape).

The optical read/write apparatus of this embodiment includes a spindle motor 2 which rotates an optical disc 1, a first optical pickup 3 which irradiates the optical disc 1 with a light beam to write data on the optical disc 1, and a second optical pickup 4 which also irradiates the optical disc 1 with a light beam to detect the light that has been reflected from an area of the optical disc on which data has been written by the first optical pickup 3. This optical read/write apparatus further includes an evaluation section (which will be referred to herein as a “waveform distortion measuring section”) 14 which makes the second optical pickup 4 detect the light that has been reflected from that area of the optical disc on which data has been written and obtains the distortion evaluation value of a signal waveform representing the reflected light while the optical disc 1 is being rotated by the spindle motor 2, and a control section (which will be referred to herein as a “controller”) 16 which controls the power of the light beam emitted from the first optical pickup 3 based on that evaluation value.

The data to be written on the optical disc 1 is supplied from a host (not shown) through the controller 16 to an ECC encoder 13, where an error correction code is added to the data. Next, the data is scrambled by a modulator 12 and an error correction code, address information and other pieces of information are added to the data, thereby modulating the data into length information such as marks and spaces. Subsequently, in accordance with the length information such as marks and spaces, a laser control section 11 turns ON and OFF the laser light source of the first optical pickup 3 with the power specified by the controller 16, thereby writing data on the optical disc 1. In the meantime, a signal which represents the light that has been reflected from the optical disc 1 and which has already been detected by the first optical pickup 3 is amplified by a pre-amplifier 5. A servo control section 10 locates the light beam spot based on the amplified signal representing the reflected light, thereby controlling the objective lens so that the light beam is condensed right on the intended location on the target recording track of the optical disc 1. Such a control is called a “focus control” and a “tracking control”.

Another laser control section 15 activates the laser light source of the second optical pickup 4 with the power specified by the controller 16. The signal representing the light that has been reflected from the optical disc 1 is detected by the second optical pickup 4 and then amplified by the pre-amplifier 5. And the servo control section 10 calculates the location of the light beam spot based on the reflected light signal that has been amplified. Then, the servo control section 10 controls the objective lens of the second optical pickup 4 so that the light beam emitted from the second optical pickup 4 irradiates the best location on the track near the location being irradiated with the light beam emitted from the first optical pickup 3 in accordance with the instruction given by the controller 16. The reflected light signal that has been amplified has its waveform shaped by an AGC equalizer 6, and then converted into a digital signal by an A/D converter 7. As for the signal that has been digitized in this manner, the waveform distortion measuring section 14 measures the β value or the degree of asymmetry and the jitter or iMLSE. According to this embodiment, the distortion evaluation values of the signal waveform obtained by the evaluation section (i.e., the waveform distortion measuring section) 14 are the “β value or the degree of asymmetry” and the “jitter or iMLSE”. In this case, the “β value or the degree of asymmetry” is a first evaluation value that increases as the power of the laser beam of the first optical pickup 3 rises. On the other hand, the “jitter or iMLSE” is a second evaluation value with a local minimum value at which the second evaluation value decreasing starts to increase as the power of the laser beam of the first optical pickup 3 rises.

Although the β value or the degree of asymmetry and the jitter or iMLSE are supposed to be measured in this embodiment after the A/D conversion, those analog signals may be measured as they are without being digitized. Also, the AGC equalizer 6 does not have to be used.

In this embodiment, the verify operation is performed by getting the data that has been written by the first optical pickup 3 read by the second optical pickup 4, even though it is not absolutely necessary to do that. The read signal that has been converted into a digital signal by the A/D converter 7 of the second optical pickup 4 is demodulated by a demodulator 8. By comparing this demodulated read data to the ECC encoded write data, the quality of the signal that has been written on the optical disc 1 can be evaluated and the verify operation can be performed. However, the verify operation is not necessarily performed in this manner. Alternatively, the verify operation may also be performed by making error correction with the demodulated read data input to the ECC decoder 9 and by comparing the demodulated read data to the error corrected read data. Or the verify operation may also be performed by seeing if correction can be made by the ECC decoder 9.

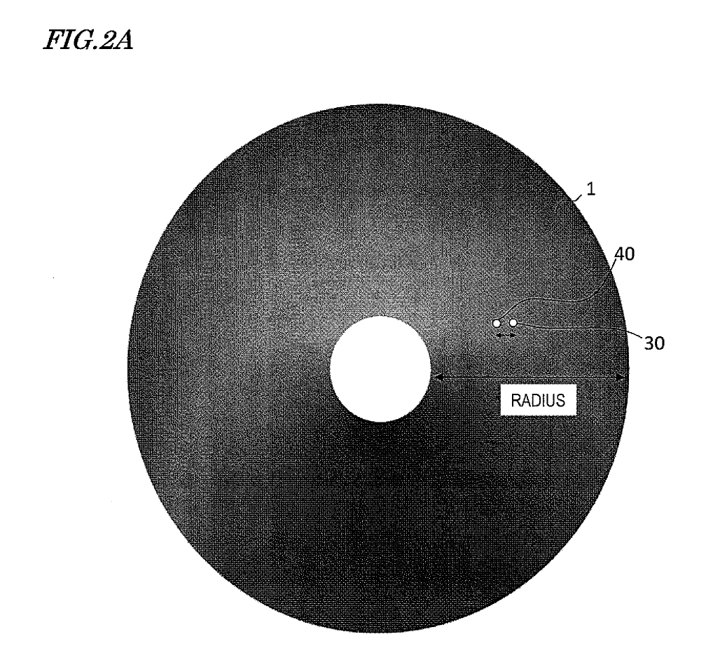

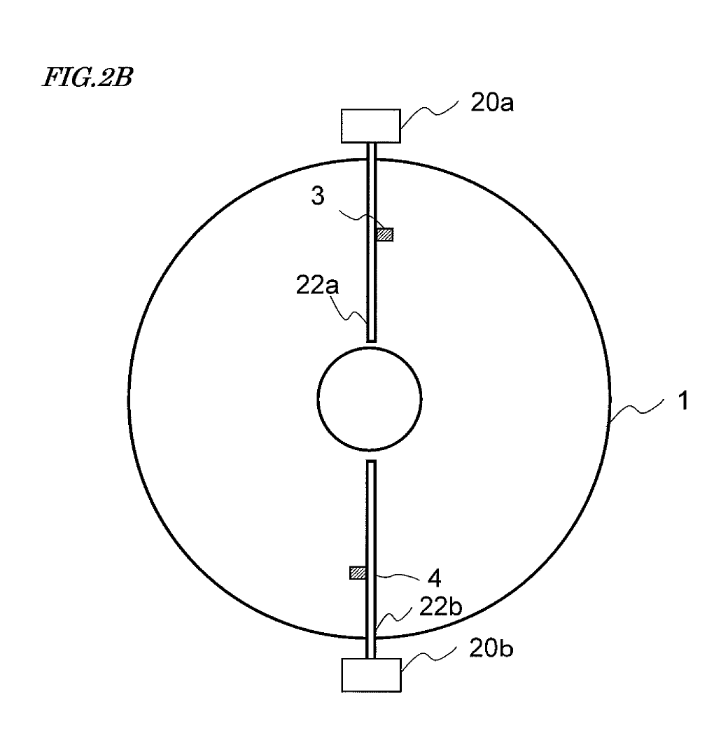

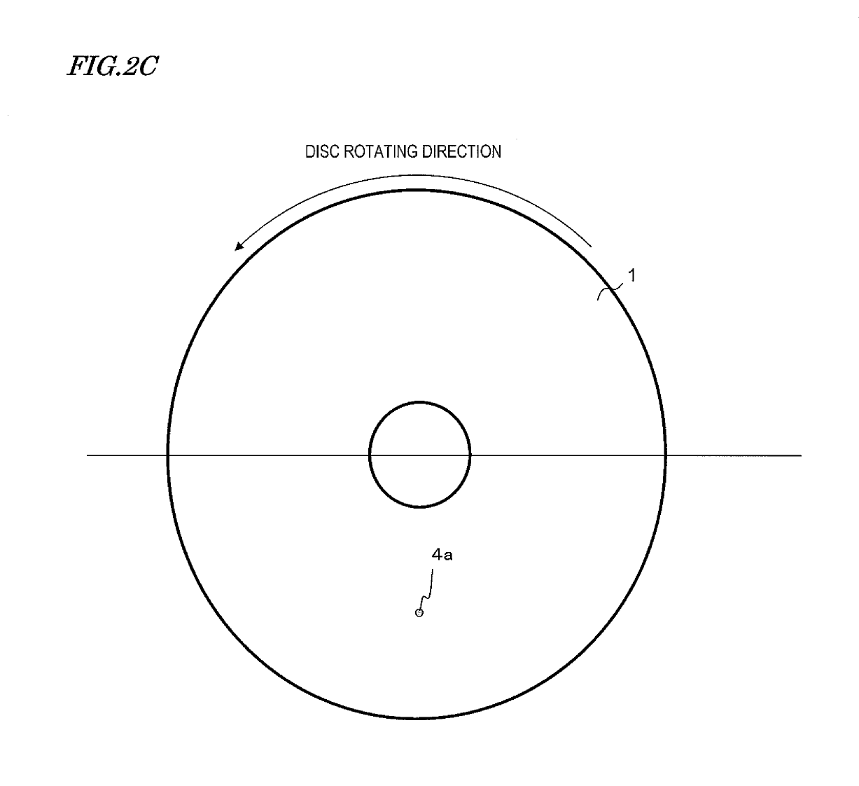

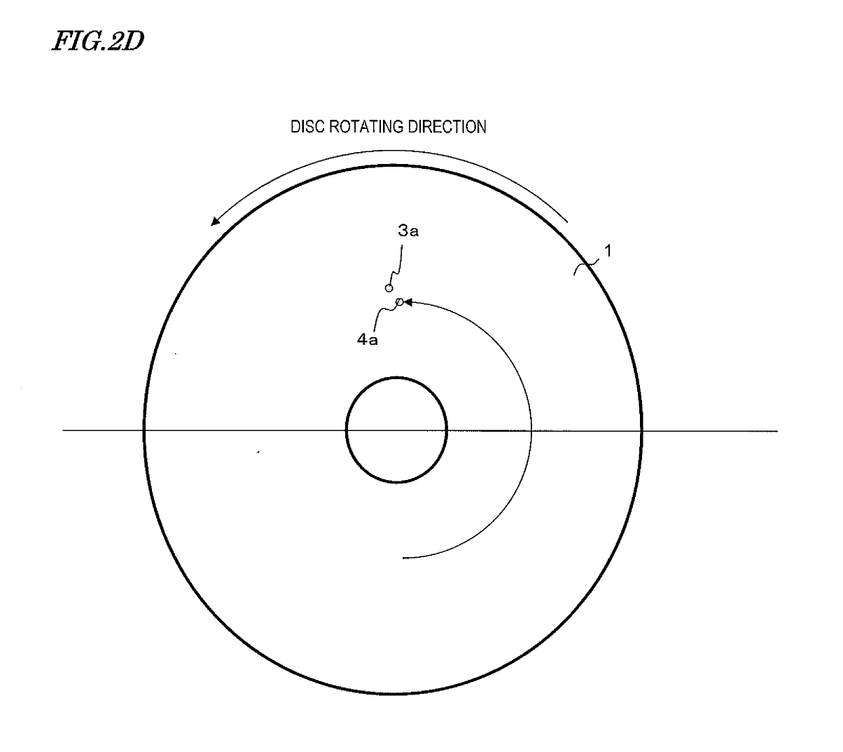

FIG. 2A illustrates a relation between the uneven sensitivity of the optical disc 1 and two points 30 and 40 that are located close to each other on the optical disc 1. Generally speaking, an optical disc will have various factors that would make the sensitivity uneven such as uneven application of the recording layer, uneven sputtering, uneven thickness of the cover layer, and its own warp. Considering this uneven sensitivity, the two points 30 and 40 that are located close to each other (e.g., within a distance of 4 mm or less) on the optical disc 1 have very similar characteristics. That is why the two optical pickups 3 and 4 may be arranged so that there is an interval of 4 mm or less between a location where data is going to be written (e.g., the point 30 shown in FIG. 2A) and a location where the distortion of the waveform is detected (e.g., the point 40 shown in FIG. 2A). However, this does not necessarily require that the two optical pickups 3 and 4 themselves be arranged close to each other, as will be described later. That is why by the time when data starts to be written by the first optical pickup 3, the waveform distortion just needs to have been detected by the second optical pickup 4 in the vicinity of the spot to be left by the light beam being emitted from the first optical pickup 3 (e.g., the point 30). Since the optical disc 1 is rotating, the location on the optical disc 1 where the waveform distortion has been detected by the second optical pickup 4 (e.g., the point 40) moves in the interval between a point in time when the waveform distortion was detected and a point in time when data is written near the waveform distortion detected location.

If the write operation is to be performed spirally from the inner edge of the optical disc (i.e., the edge closer to the center of the optical disc) toward its outer edge as in a single-layer BD (Blu-ray Disc), then the second optical pickup 4 is suitably arranged closer to the inner edge than the first optical pickup 3 is and those optical pickups 3 and 4 are suitably arranged so that the tracks the two optical pickups face are located close to each other. In this description, if the tracks are located “close to each other”, then it means that there is an interval of 4 mm or less between the spot left by the light beam emitted from the first optical pickup 3 (i.e., the data writing location) and the spot left by the light beam emitted from the second optical pickup 4 (i.e., the waveform distortion detected location).

FIG. 2B illustrates an example of a mechanism for controlling the positions of the optical pickups 3 and 4. In FIG. 2B, illustrated are exemplary traverse devices 20a and 20b which can move the two optical pickups 3 and independently of each other. The optical pickup 3 moves in the radial direction of the optical disc 1 along the guide 22a of the traverse device 20a. In the same way, the optical pickup 4 moves in the radial direction of the optical disc 1 along the guide 22b of the traverse device 20b. By adopting such traverse devices 20a and 20b, the radial positions of the two optical pickups 3 and 4 can be changed with respect to the rotating optical disc 1 so that the light beam spots left by the two optical pickups 3 and 4 on the rotating optical disc 1 are located close to each other. Optionally, any one of the two optical pickups 3 and 4 may be moved toward either the inner edge or the outer edge of the optical disc 1.

FIG. 2C shows the location 4a of the light beam spot left by the second optical pickup 4. The location 4a falls within the area where data has already been written by the first optical pickup 3. The second optical pickup 4 reads a signal based on the data that has been written on the location 4a, thereby evaluating the waveform distortion at the location 4a.

FIG. 2D illustrates a positional relation between the location 3a of the light beam spot left by the first optical pickup 3 and the location 4a of the light beam spot left by the second optical pickup 4. In the state shown in FIG. 2D, the optical disc 1 has rotated half the way around from the state shown in FIG. 2C. In the example illustrated in FIG. 2D, data is written on the location 3a of the light beam spot left by the first optical pickup 3. The laser power of the first optical pickup 3 that is writing data on this location 3a is determined based on the waveform distortion evaluation value obtained from its neighboring location 4a.

In a multilayer optical disc, the data writing direction sometimes changes every storage layer from outward (i.e., from an inner area toward the outer edge) into inward (i.e., from an outer area toward the inner edge), and vice versa. In that case, in processing such a layer on which data needs to be written from an inner area of the disc toward its outer edge, the second optical pickup 4 is arranged inside of the first optical pickup 3 as described above. On the other hand, in processing a layer on which data needs to be written from an outer area of the disc toward its inner edge, the second optical pickup 4 is arranged outside of the first optical pickup 3.

In general, it will take a while (e.g., in the range of approximately 10 ms to 100 ms) for a recorded mark to have a stabilized shape, even though the amount of time it takes may vary according to the material property of the storage layer or the temperature of the environment surrounding the disc during writing. In the apparatus disclosed in Japanese Laid-Open Patent Publication No. 2007-80407, the two optical pickups are arranged so that a sector on which data has just been written is scanned and verified on the same track. This is done for the purpose of sensing deterioration in write quality and stopping the write operation as soon as possible. Taking a BD as an example, however, if a sector on which data has just been written is scanned, there will be as short a time interval as 156 μs between writing and reading when the write operation is performed at 6× speeds and the recorded mark cannot be formed fully during that short time interval. Even in such a state, the write quality can still be determined to be good or bad and the verify operation can still get done because a recorded mark that could come to have good write quality afterward may be determined to be a bad one but because the opposite situation rarely happens if ever (i.e., a recorded mark that could come to have bad write quality afterward is rarely determined to be a good one).

According to this embodiment, however, the laser power is controlled by making feedback of the waveform distortion measured value, and therefore, it is recommended to avoid using such a value measured right after a write operation has been performed because such a measured value could be quite different from the value measured after the mark has been stabilized.

Due to the uneven sensitivity of an optical disc, the shorter the distance between two locations on the disc, the closer their characteristics should be. If the beam spots left by a light beam for writing and a light beam for measuring are located in two adjacent sectors on the same track, the locations of these two light beam spots will have as long a distance as 4.4 mm between them. In a situation where the waveform distortion is supposed to be measured in 100 ms in which a recorded mark gets stabilized, even if the optical disc is rotating at 10000 rpm, the disc will have rotated less than 17 times in 100 ms. In this case, even if measurement is supposed to be made after a write operation has been performed on 17 tracks, the interval between writing and measuring will be just 5.4 μm because the track pitch is 0.32 μm. For that reason, according to this embodiment, the spots of the light beams for writing and reading are suitably arranged close to each other in the radial direction of the optical disc 1 in view of the stability of the mark shapes and the uneven sensitivity of the disc.

Hereinafter, it will be described how this optical read/write apparatus performs a write operation and a measuring operation.

### 1-2. Operation

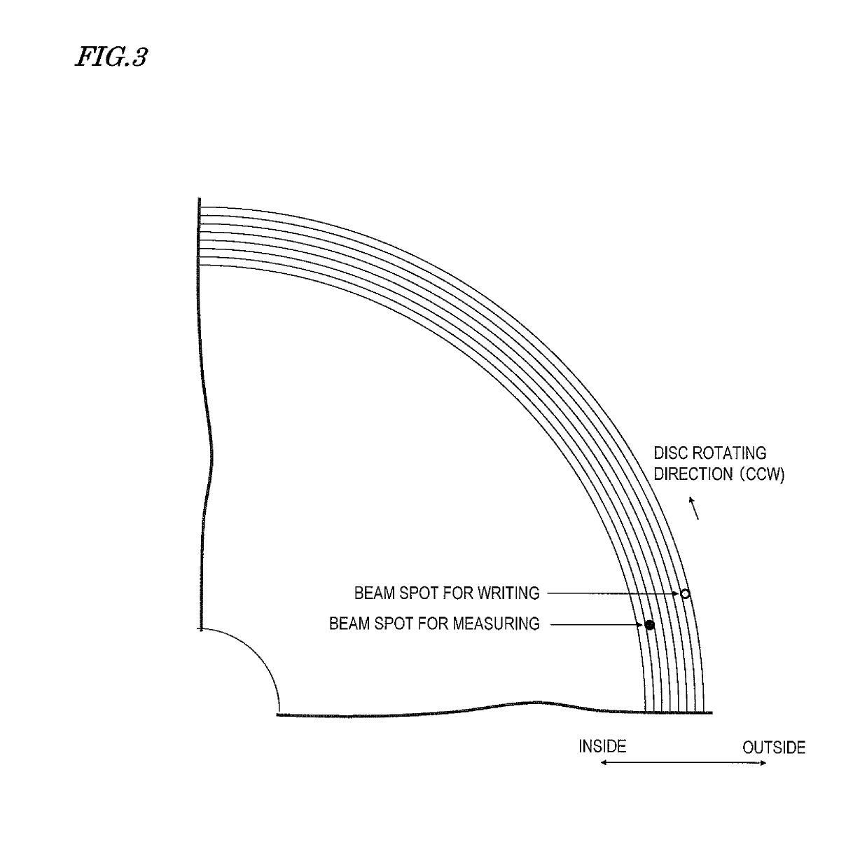

FIG. 3 illustrates how to perform a write operation and a measuring operation to get waveform distortion information using the two optical pickups 3 and 4. In the example illustrated in FIG. 3, a disc on which a write operation is performed spirally from the inner edge of an optical disc toward its outer edge as in a single-layer BD is supposed to be used. As described above, a location on which a write operation has been performed slightly before both temporally and spatially using the write light beam emitted from the first optical pickup 3 is scanned with the measuring light beam emitted from the second optical pickup 4, and the waveform distortion information thus obtained is fed back to writing. In the example illustrated in FIG. 3, the spot of the measuring beam is located five tracks before the spot of the write light beam. In the following description, the distance from the center of the optical disc 1 to a spot of a light beam will be referred to herein as the “radial location” of the light beam spot. The distance between the respective radial locations of the measuring and write beam spots does not have to be five tracks but may also be ten tracks or more as long as the distance is 4 mm or less.

The write data is supplied from a host (not shown in FIG. 1) through the controller 16 to the ECC encoder 13, where an error correction code is added to the data. Next, the data is modulated by the modulator 12. Then, in accordance with the modulated data, the laser control section 11 turns ON and OFF the laser light source with the power specified by the controller 16, thereby producing a light beam for writing.

At this point in time, to perform a feedback control of the power, the controller 16 stores the write laser power at that writing location in a memory. In addition, to perform a verify operation, the controller 16 also stores the EGO encoded write data at that writing location in the memory.

In the meantime, in the second optical pickup 4, a signal representing the light that has been reflected from the optical disc 1 is detected, amplified by the pre-amplifier 5, further amplified by the AGC equalizer 6, digitized by the A/D converter 7, and then has its β value or degree of asymmetry and the jitter measured by the waveform distortion measuring section 14.

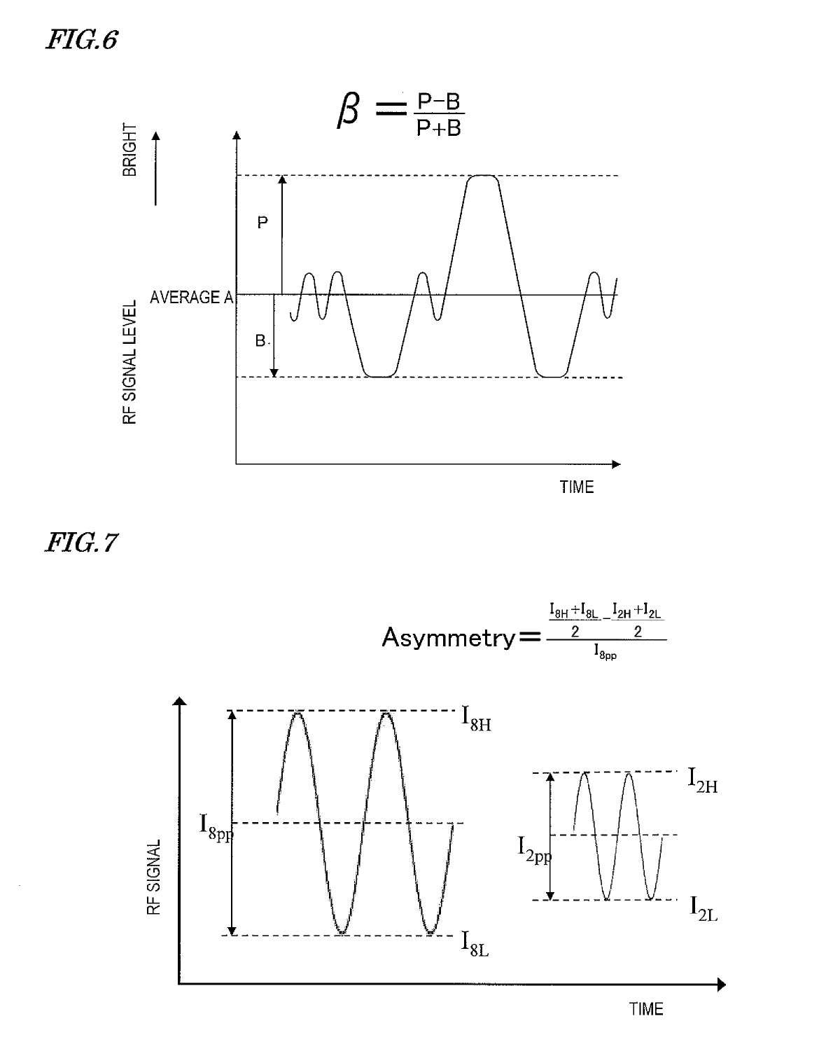

In this case, β as a piece of the waveform distortion information is an index indicating the bias of the average value with respect to the maximum amplitude of a measured RF signal as shown in FIG. 6 and can be calculated by (P−B)/(P+B).

Meanwhile, the degree of asymmetry as another piece of the waveform distortion information is an index indicating the bias of the average of the longest marks and spaces and that of the average of the shortest marks and spaces in the measured RF signal as shown in FIG. 7. And the degree of asymmetry is calculated by ((I_{8H}+I_{8L})/2−(I_{2H}+I_{2L})/2)/I_{8PP}.

Next, it will be described how to make feedback of power control according to this embodiment.

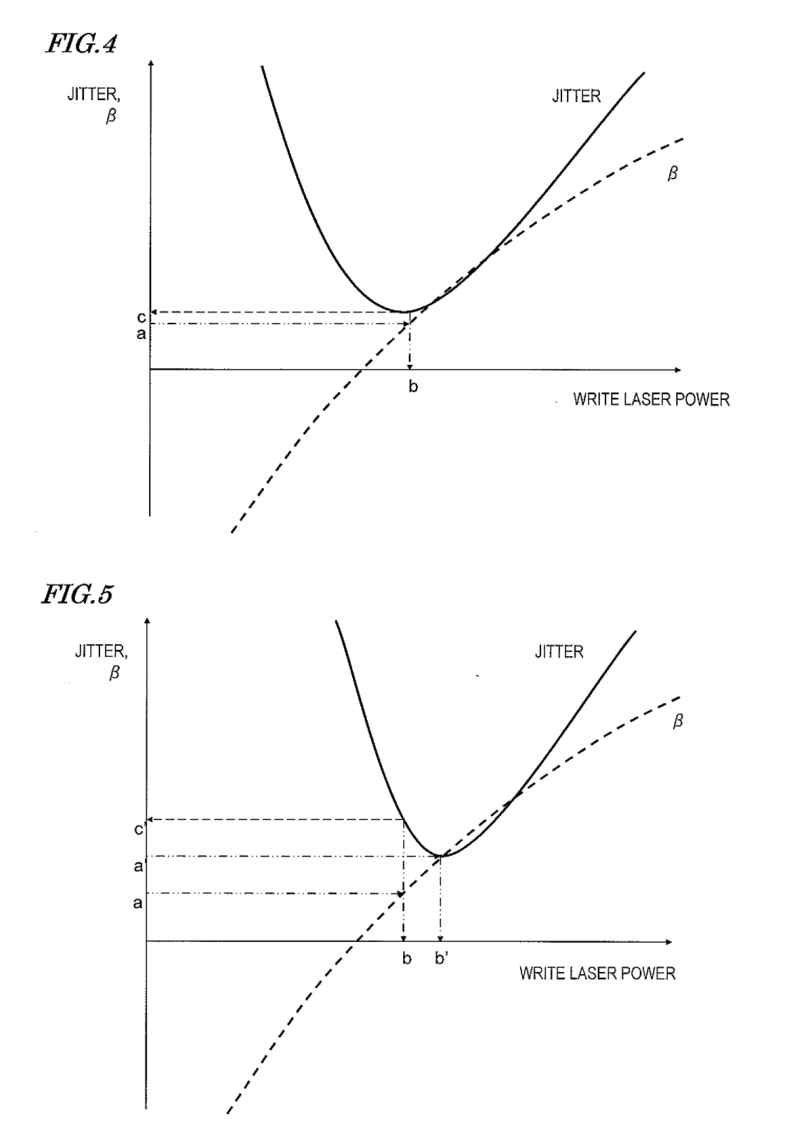

FIG. 4 is a graph showing the write laser power dependences of the jitter (indicated by the solid curve) and the β value (indicated by the dashed curve) at a certain location on the optical disc 1. As can be seen easily from FIG. 4, the jitter has a local minimum value at which the jitter decreasing starts to increase as the write laser power rises. On the other hand, the β value increases as the write laser power rises. Although not shown in FIG. 4, the degree of asymmetry described above also has the same write laser power dependence as the β value.

The relation between the write laser power and the β value and the relation between the write laser power and the jitter such as the ones shown in FIG. 4 may be obtained by performing a test write operation in advance on a test write area (OPC area) before writing data. The data representing those relations may be stored in a memory in the optical read/write apparatus as a table of correspondence between the jitter and the write laser power and as a table of correspondence between the β value and the write laser power.

In the graph shown in FIG. 4, when the jitter has the optimum value c, the β value is “a” and the write laser power is “b”. If the β value is lower than “a”, it means that the write laser power when the data was written was lower than “b”. Conversely, if the β value is higher than “a”, it means that the write laser power when the data was written was higher than “b”. That is why after user data has started to be written, the β value is detected by the second optical pickup 4 and the write laser power may be controlled based on the β value detected so as to satisfy β=a. For example, if the β value measured by the second optical pickup 4 turns out to be lower than what it should be (i.e., the value “a”), then the controller 16 adds the deficit of the power to the power when data was written at that address by reference to the table and instructs the laser control section 11 to perform a write operation with the corrected write laser power “b”.

However, the relation shown in FIG. 4 is not always satisfied over the entire storage plane of the optical disc 1 or may vary due to a variation in environmental temperature. The relation shown in FIG. 4 may be satisfied in a neighboring range on the optical disc 1 but may not be satisfied at a distant location. If the relation shown in FIG. 4 indicates the write laser power dependences of the jitter (represented by the solid curve) and the β value (represented by the dashed curve) that have been obtained in the test write area (OPC area), the relation shown in FIG. 4 may not be satisfied at a location that is far away from the test write area on the same optical disc.

FIG. 5 is a graph showing the write laser power dependences of the jitter (represented by the solid curve) and the β value (represented by the dashed curve) at a different location on the optical disc 1. The shapes of the curves shown in FIG. 5 are different from those of the curves shown in FIG. 4. In the example shown in FIG. 5, the power margin runs short in a low power range. Specifically, in this example, when β=a, the jitter does not have the optimum value “c” but has a worse value “c′”. In that case, even if the write laser power is controlled so as to satisfy β=a, “c′” is much worse than the optimum jitter value “c” shown in FIG. 4. If it has turned out that the jitter value has deteriorated, then the β value and the jitter are measured with the write laser power changed gradually so as not to debase the write quality significantly, thereby obtaining a new optimum β value “a′”. After that, the controller 16 adjusts the write laser power to “b′” so as to satisfy β=a′.

As can be seen from the foregoing description, if only the β value is measured while user data is being written, it is impossible to sense the curves shown in FIG. 4 change into the ones shown in FIG. 5 during the write operation. However, if the jitter and the β value are both measured, it is possible to sense a variation in the β value that minimizes the jitter. To detect such an optimum β value, there is no need to obtain in advance the relation such as the one shown in FIG. 5 at every location on the optical disc 1. If the jitter and the β value are both measured by the second optical pickup 4 while user data is being written by the first optical pickup 3, the variation in the β value that minimizes the jitter can be sensed in real time.

Optionally, the same kind of control can be carried out by detecting the degree of asymmetry instead of the β value. Or the same control can also be performed by using yet another distortion evaluation value other than the β value, the degree of asymmetry and the jitter. That is to say, the effect of this embodiment can be achieved by using, as distortion evaluation values of a signal waveform, a first evaluation value that increases as the write laser power rises and a second evaluation value with a local minimum value at which the second evaluation value decreasing starts to increase as the write laser power rises. iMLSE is one of those second evaluation values. It should be noted that iMLSE is an evaluation value indicating the error rate correlation for use in a decoding system that adopts a PRML (partial response maximum likelihood) bit detecting method.

According to this embodiment, the verify operation is supposed to be performed by getting the data being written read by the second optical pickup 4 simultaneously. The read signal that has been digitized by the A/D converter 7 of the second optical pickup 4 shown in FIG. 1 is demodulated by the demodulator 8. By comparing this demodulated read data to the ECC encoded write data stored in the controller 16, the quality of the signal stored on the optical disc 1 can be evaluated. If the result of the verify operation is NG, then a replacement write operation may be performed on another address.

The operation described above relates to controlling the write laser power based on the distortion evaluation value (i.e., a real time control) after user data has started to be written on the optical disc 1. Before starting to write the user data, the operation of setting a write laser power initial value that seems to be the best for the optical disc 1 may be carried out. Such an initial value may be determined by trying writing test marks with multiple different write powers on a learning area of the optical disc 1 that has been loaded into the apparatus and by choosing the best write power based on the qualities of the read signals representing those test marks.

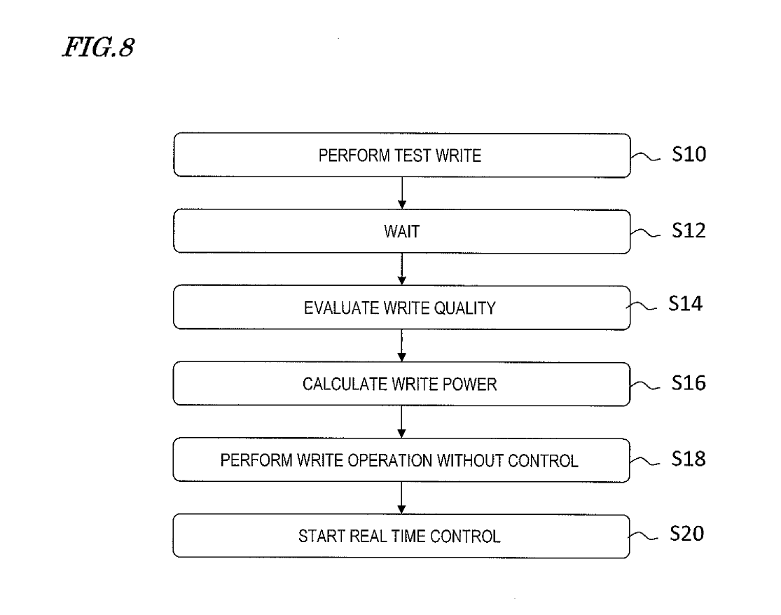

Hereinafter, it will be described with reference to FIG. 8 how such an operation of determining a write laser power initial value may be carried out.

First in Step S10, test data is written on the basis of either a minimum unit for writing data or several minimum units (i.e., a test write operation is performed). This “minimum unit” may be a single unit of a cluster, an RUB (recording unit block) or an ECC (error correction code). The test data is written on a learning area which is defined close to the innermost area of the optical disc 1 with the value of the write laser power changed.

It takes a time of approximately 100 ms, for example, for a recorded mark to get stabilized after the test data has been written. In Step S12, the optical disc 1 is rotated until the recorded marks get sufficiently stabilized, thereby stabilizing the reflectances and shapes of recorded marks that form the test data.

Next, in Step S14, after the recorded marks have gotten sufficiently stabilized, a signal is read from the area on which the test data has been written and the quality of the read signal is evaluated. The quality of the read signal can be evaluated with the “β value or the degree of asymmetry” and the “jitter” described above.

Then, in Step S16, the optimum write laser power is determined based on the evaluation value. By measuring the β value and the jitter in Step S14, discrete data points that form the curves shown in FIG. 4 can be obtained. And the curves that connect those data points may be approximated by a polynomial such as a quadratic. In one embodiment, the write power that minimizes the jitter can be calculated using such an approximation formula.

Subsequently, in Step S18, user data starts to be written with the write laser power, of which the value has been determined by the method described above.

Finally, in Step S20, after a predetermined amount of time which is longer than the time it takes to get a recorded mark stabilized has passed, the real time control described above is started.

As for an optical disc 1 on which user data has been written once, if the value of the write laser power that was used when data was written there last time is stored in the memory of an optical read/write apparatus or on the optical disc 1 itself, then the value can be read from the memory or the optical disc 1 and adopted as an initial value. As described above, the optimum value of the write laser power may vary from one location on the optical disc 1 to another. That is why multiple write laser power values may be stored as a table of correspondence with various locations on the optical disc 1 either in the memory of the optical read/write apparatus or on the optical disc 1. In newly writing user data on the optical disc 1, if the write laser power value at the nearest location to the location where the user data is going to be written is read from the memory, the most appropriate initial write laser power value to newly write user data with can be obtained.

### 1-3. Effects

According to the embodiments of the present disclosure, the apparatus includes the waveform distortion measuring section 14 which makes the second optical pickup 4 detect a signal representing the light that has been reflected from an area on the optical disc 1 on which data has been written, thereby obtaining the distortion evaluation value of a signal waveform representing the reflected light and the laser control section 11 which controls the power of the light beam emitted from the first optical pickup 3 based on the distortion evaluation value. As a result, feedback of the power control can be made and a stabilized write quality can be maintained.

Various embodiments of the present disclosure have been described by providing the accompanying drawings and a detailed description for that purpose.

That is why the elements illustrated on those drawings and/or mentioned in the foregoing detailed description include not only essential elements that need to be used to overcome the problems described above but also other inessential elements that do not have to be used to overcome those problems but are just mentioned or illustrated to give an example of the present disclosure. Therefore, please do not make a superficial decision that those inessential additional elements are indispensable ones simply because they are illustrated or mentioned on the drawings or the description.

Also, the embodiments disclosed herein are just an example of the present disclosure, and therefore, can be subjected to various modifications, replacements, additions or omissions as long as those variations fall within the scope of the present disclosure as defined by the appended claims and can be called equivalents.

An optical read/write apparatus according to the present disclosure can write data over a broad range on an optical storage medium with a light beam with the optimum power, and therefore, can be used effectively to make archives of important data.

While the present invention has been described with respect to embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2012-010656 filed Jan. 23, 2012 and No. 2012-239724 filed Oct. 31, 2012, the entire contents of which are hereby incorporated by reference.

What is claimed is:

1. An optical read/write apparatus which performs both the operation of writing data on an optical storage medium and the operation of reading data that has been written on the storage medium, the apparatus comprising:
a motor which drives the optical storage medium;
a first optical pickup which irradiates the optical storage medium with a first light beam, thereby writing data on the optical storage medium;
a second optical pickup which irradiates the optical storage medium with a second light beam and detects the second light beam that has been reflected from the optical storage medium, thereby reading the data that has been written by the first optical pickup on the optical storage medium;
an evaluation section which obtains a distortion evaluation value of a signal waveform representing the reflected light that has been detected by the second optical pickup while the optical storage medium is being driven by the motor; and
a control section which controls, based on the distortion evaluation value, the power of the first light beam emitted from the first optical pickup.

2. The optical read/write apparatus of claim 1, wherein the distortion evaluation value of the signal waveform includes a first evaluation value that increases as the power of the first light beam rises and a second evaluation value with a local minimum value at which the second evaluation value decreasing starts to increase as the power of the first light beam rises, and
wherein the control section controls the power of the first light beam based on both of the first and second evaluation values.

3. The optical read/write apparatus of claim 2, wherein the first evaluation value is at least one of the β value and the degree of asymmetry of the signal waveform representing the reflected light, and the second evaluation value is at least one of the jitter and iMLSE of the signal waveform representing the reflected light.

4. The optical read/write apparatus of claim 1, wherein the apparatus performs a verify operation by getting the data that has been written by the first optical pickup read by the second optical pickup.

5. The optical read/write apparatus of claim 1, wherein the first and second optical pickups are arranged so that there is an interval of 4 mm or less between two beam spots left by the first and second light beams on the optical storage medium.

6. The optical read/write apparatus of claim 5, wherein the optical storage medium is an optical disc to be rotated by the motor, and
wherein the first and second optical pickups are arranged so as to irradiate the optical disc with the first and second light beams at two different radial locations.

7. The optical read/write apparatus of claim 2, comprising a memory which stores information about a relation between the power of the first light beam and the first evaluation value and information about a relation between the power of the first light beam and the second evaluation value,
wherein by reference to the information stored in the memory, the control section controls the power of the first light beam so as to obtain the first evaluation value when the second evaluation value becomes a local minimum value.
